(19) United States
(12) Patent Application Publication
(10) Pub. No.: US 2008/0246718 A1
(43) Pub. Date: Oct. 9, 2008

(54) LIQUID CRYSTAL DISPLAY DEVICE

(75) Inventor: Yasuhiro Tanaka, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/060,282

(22) Filed: Apr. 1, 2008

(30) Foreign Application Priority Data
Apr. 3, 2007 (JP) 2007-097033

(51) Int. Cl. G09G 3/36

(52) U.S. Cl. 345/94

(57) ABSTRACT

A liquid crystal display device including an image line drive circuit having an amplifier circuit for outputting an image voltage to an image line. The amplifier circuit has a switching unit for connecting one of two input terminals to either of an inverting input terminal or a non-inverting input terminal and also for connecting the other of the two input terminals to the remaining one out of the inverting input terminal or the non-inverting input terminal. The switching unit switches, according to a switching control signal input every two display lines, one of the two input terminals of the amplifier circuit to an inverting input terminal and the other of the two input terminals to a non-inverting input terminal or switches one of the two input terminals of the amplifier circuit to the non-inverting input terminal and the other of the two input terminals to the inverting input terminal.

### CLAIM OF PRIORITY

The present application claims priority from Japanese Application JP 2007-097033 filed on Apr. 3, 2007, the content of which is hereby incorporated by reference into this application.

### BACKGROUND OF THE INVENTION

1. Field of the Invention

The present invention relates to a liquid crystal display device, and more specifically to a technique effective when applied to a drain driver for a liquid crystal display device capable of multi-gray-scale display.

2. Description of the Related Art

A liquid crystal display module is used as a high-definition color monitor for a computer and other information technology devices or as a display device for a TV receiver.

The liquid crystal display module generally has a so-called liquid crystal display panel having a liquid crystal layer held between two (a pair of) substrates, at least one of which is made of transparent glass or the like, in which voltages are selectively applied to various electrodes of sub-pixels formed on the liquid crystal display panel to turn on or off particular sub-pixels. The display module is excellent in contrast performance as well as in high-speed display performance.

FIG. 11 is a block diagram illustrating a schematic configuration of a liquid crystal display module based on the conventional technology.

The liquid crystal display module shown in FIG. 11 has a liquid crystal display panel 1, a drain driver 2, a gate driver 3, a display control circuit 4, and a power circuit 5.

The drain driver 2 and the gate driver 3 are provided in peripheral portions of the liquid crystal display panel 1. The gate driver 3 comprises a plurality of gate drivers ICs provided on one edge of the liquid crystal display panel 1. The drain driver 2 comprises a plurality of drain drivers ICs provided on another edge of the liquid crystal display panel 1.

The display control circuit 4 performs timing control appropriate for display on the liquid crystal display panel 1, such as AC-conversion of data, on display signals received from a display signal source (host side) such as a personal computer or a TV receiver circuit to convert the signals to display data in a desired display format. The display control circuit 4 then inputs the display data to the gate driver 3 and to the drain driver 2 together with synchronization signals (clock signals). The power circuit 5 generates various types of voltages necessary for the liquid crystal display module.

In FIG. 11, reference symbol DL denotes an image line (also referred to as a drain line or source line), GL denotes a scanning line (also referred to as a gate line), and PX denotes a pixel electrode for each of red, green, and blue colors. Also, reference symbol CT denotes an opposite electrode (also referred to as a common electrode), LC denotes a liquid crystal capacitor equivalently showing a liquid crystal layer, and Cadd denotes a storage capacitor between the opposite electrode (CT) and the pixel electrode (PX).

In the liquid crystal display panel 1 shown in FIG. 11, drain electrodes of thin-film transistors (TFT) for sub-pixels arrayed in the column direction are each connected to the image lines (DL). The image lines (DL) are each connected to the drain driver 2 for supplying an image voltage corresponding to the display data to the sub-pixels arrayed in the column direction.

The gate electrodes of thin-film transistors (TFT) in the sub-pixels arrayed in the row direction are each connected to the scanning lines (GL). Each of the scanning lines (GL) is connected to the gate driver 3 for supplying a scanning voltage (positive or negative bias-voltage) to a gate of each thin-film transistor (TFT) for one horizontal scanning time.

The gate driver 3 supplies a scanning voltage to the scanning line (GL) based on control by the display control circuit 4. The drain driver 2 supplies an image voltage to the image line (DL) for displaying an image based on control by the display control circuit 4.

When an image is to be displayed on the liquid crystal display panel 1, the gate driver 3 selects a scanning line (GL) scanning from top to bottom (or vice versa). While a particular scanning line (GL) is being selected, the drain driver 2 also supplies an image voltage corresponding to the display data to an image line to apply the voltage to a pixel electrode (PX).

The voltage supplied to the image line (DL) is applied via a thin-film transistor (TFT) to the pixel electrode (PX). Finally an electric charge is charged to the storage capacitor (Cadd) and the liquid crystal capacitor (LC) for controlling liquid crystal molecules to display the image.

The drain driver 2 has a multiple-gray-scale voltage generator circuit, a gray-scale voltage selector circuit for selecting one gray-scale voltage corresponding to the display data from among the multiple-gray-scale voltages generated by the multiple-gray-scale voltage generator circuit, and an amplifier circuit to which the one gray-scale voltage selected by the gray-scale voltage selector circuit is input.

Recently, in the field of liquid crystal display modules, the number of scales in the multiple gray-scale display has increased from 64-gray-scale display to 256-gray-scale display, and a voltage width of one gray-scale (namely, a potential difference between adjoining gray-scale voltages generated by the multiple-gray-scale voltage generator circuit) has become smaller.

On the other hand, in its amplifier circuit, an offset voltage is generated due to characteristic variation of active elements constituting the amplifier circuit. When an offset voltage is generated in the amplifier circuit, an error occurs in an output voltage from the amplifier circuit, and the output voltage from the amplifier circuit thus differs from a target value (a proper gray-scale voltage). Accordingly, a black or white stripe/stripes is/are generated in a display screen displayed on the liquid crystal display panel 1, which leads to a problem of degraded display quality.

As a solution to the above problem, a method is known in which the offset voltage is canceled by switching one of two input terminals of the amplifier circuit to an inverting input terminal and the other to a non-inverting input terminal or vice versa with the use of a switch control signal (the method is hereinafter referred to as an “offset-voltage canceling method based on the chopper control system) (Refer to Japanese patent No. 3595153).

A prior art document related to the present invention is given below:

Japanese patent No. 3595153

### SUMMARY OF THE INVENTION

Generally, when the same voltage (DC voltage) is applied to a liquid crystal layer for a long time, an inclination of the liquid crystal layer is fixed. As a result, this causes a residual image phenomenon, shortening the life duration of the liquid crystal layer. To prevent this, in a liquid crystal display module, a voltage applied to the liquid crystal layer is converted to an alternating voltage at regular time intervals. In other words, a voltage applied to a pixel electrode (PX) is changed to the positive voltage side or the negative voltage side at regular time intervals based on a voltage applied to an opposite electrode (CT).

There has been known the common symmetry method as an AC-drive method in which an AC voltage is applied to the liquid crystal layer. In the common symmetry method, a voltage applied to an opposite electrode (CT) is fixed at a certain level; based on this, a voltage applied to a pixel electrode (PX) is inverted alternately from the positive side to the negative side. As examples of the common symmetric method, there has been known the dot inversion method or the N-line inversion method.

Recently, for the purpose of cost reduction, the number of output lines from one drain driver has been increased to reduce the number of drain drivers used in a liquid crystal display module. When the dot inversion method is employed as an AC-drive system for a liquid crystal display module under the above condition, an amount of heat generated by each drain driver disadvantageously increases.

As an AC-drive system for a liquid crystal display module, therefore, the column-by-column inversion method as shown in FIG. 12 is employed favorably. In this column-by-column inversion method, in a particular frame period, an image voltage with positive polarity (or negative polarity) is supplied from the drain driver 2 to even-number-th image lines (DL), and at the same time an image voltage with negative polarity (or positive polarity) is supplied to odd-number-th image lines (DL). Then in the next frame period, an image voltage with negative polarity (or positive polarity) is supplied from the drain driver 2 to even-number-th image lines (DL), and at the same time an image voltage with positive polarity (or negative polarity) is supplied to odd-number-th image lines (DL).

Furthermore, there has been known the pseudo dot inversion method shown in FIG. 13 as an example of the column-by-column inversion method.

In the pseudo dot inversion method, pixel electrodes (PX) connected to one of the two adjoining image lines (DL) (for instance, DL1) via thin-film transistors (TFT) and those (PX) connected to the other image line (for instance, DL2) are arranged between the two adjoining image lines (DL) alternately in the direction in which the image lines (DL) extend.

Also, within one frame period, an image voltage with positive polarity is supplied to image lines DL1, DL3, and DL5, and at the same time an image voltage with negative polarity is supplied to image lines DL2 and DL4. Accordingly, polarities of the image voltages supplied to sub-pixels are the same as those in the dot inversion method as shown in FIG. 13. In FIG. 12 and FIG. 13, squares with the sign (+) are pixel electrodes to which an image voltage with positive polarity is supplied, and squares with the sign (−) are pixel electrodes to which an image voltage with negative polarity is supplied.

In the column-by-column inversion method or in the pseudo dot inversion method described above, when the offset-voltage canceling method based on the chopper system is carried out every one frame period, flickering occurs on a display screen when a certain pattern is displayed, which disadvantageously degrades the display quality.

The present invention was made to solve the problems of the conventional technology as described above, and an object of the present invention is to provide a technique enabling prevention of flickering on a display screen in a liquid crystal display panel generated due to an offset voltage in an amplifier circuit of an image line drive circuit in a liquid crystal display device and improvement in display quality of the display screen.

The above-described and other objects and novel features of the present invention will be more clarified with reference to descriptions in the specification and the drawings attached hereto.

Of pieces of the invention disclosed herein, representative ones are briefly summarized below.

(1) The present invention provides, in one aspect, a liquid crystal display device comprising: a plurality of image lines; a plurality of scanning lines; a plurality of thin-film transistors connected to each of the image lines and each of the scanning lines; and a image line drive circuit for supplying an image voltage to each of the image lines, in which polarity of an image voltage supplied from the image line drive circuit to each of the image lines is kept constant during one frame period, and at the same time, between two successive frames, polarity of an image voltage supplied to each image line from the image line drive circuit during the former frame is different from that supplied during the latter frame,

wherein: the image line drive circuit has an amplifier circuit for outputting an image voltage to the image line; the amplifier circuit has a switching unit for connecting one of two input terminals to either of an inverting input terminal or a non-inverting input terminal and also for connecting the other of the two input terminals to the remaining one out of the inverting input terminal and the non-inverting input terminal; and the switching unit switches, according to a switching control signal input every two display lines, one of the two input terminals of the amplifier circuit to an inverting input terminal and the other of the two input terminals to a non-inverting input terminal or switches one of the two input terminals of the amplifier circuit to the non-inverting input terminal and the other of the two input terminals to the inverting input terminal.

(2) The present invention provides, in another aspect, a liquid crystal display device comprising: a plurality of image lines; a plurality of scanning lines; a plurality of thin-film transistors connected to each of the image lines and each of the scanning lines; and an image line drive circuit for supplying an image voltage to each of the image lines, the plurality of thin-film transistors provided between two adjoining image lines along a direction in which the image lines extend having such an arrangement in which thin-film transistors connected to one of the two adjoining image lines and those connected to the other of the two adjoining image lines are alternately arranged, in which polarity of an image voltage supplied from the image line drive circuit to each of the image lines is kept constant during one frame period, and at the same time, between two successive frames, polarity of an image voltage supplied to each image line from the image line drive circuit during the former frame is different from that supplied during the latter frame,

wherein: the image line drive circuit has an amplifier circuit for outputting an image voltage to the image line; the amplifier circuit has a switching unit for connecting one of two input terminals to either of an inverting input terminal or a non-inverting input terminal and also for connecting the other of the two input terminals to the remaining one out of the inverting input terminal and the non-inverting input terminal; and the switching unit switches, according to a switching control signal input every two display lines, one of the two input terminals of the amplifier circuit to an inverting input terminal and the other of the two input terminals to a non-inverting input terminal or switches one of the two input terminals of the amplifier circuit to the non-inverting input terminal and the other of the two input terminals to the inverting input terminal.

(3) In the liquid crystal display device described in (1) or (2) above, the image line drive circuit comprises: a data latch circuit for latching input display data; and a decoder circuit for selecting a gray-scale voltage based on the display data supplied from the data latch circuit, and the amplifier circuit outputs the gray-scale voltage selected by the decoder circuit as an image voltage to the image line.

(4) In the liquid crystal display device described in any of (1) to (3), a phase of the switching control signal is inverted every two frames.

(5) In the liquid crystal display device described in any of (1) to (3), a cycle of the switching control signal is twice as long as a horizontal scanning time.

(6) The present invention provides, in still another aspect, a liquid crystal display device comprising: a plurality of image lines; a plurality of scanning lines; a plurality of thin-film transistors connected to each of the image lines and each of the scanning lines; and a image line drive circuit for supplying an image voltage to each of the image lines, in which polarity of an image voltage supplied from the image line drive circuit to each of the image lines is kept constant during one frame period, and at the same time, between two successive frames, polarity of an image voltage supplied to each image line from the image line drive circuit during the former frame is different from that supplied during the latter frame,

wherein: the image line drive circuit includes an amplifier circuit for outputting an image voltage to the image line; the amplifier circuit has a switching unit for connecting one of two input terminals to either of an inverting input terminal or a non-inverting input terminal and also for connecting the other of the two input terminals to the remaining one out of the inverting input terminal and the non-inverting input terminal; and an image voltage produced by adding an offset voltage to a gray-scale voltage and an image voltage produced by subtracting the offset voltage from the gray-scale voltage are supplied alternately via the image line to the thin-film transistor every two successive horizontal-scanning periods.

(7) The present invention provides, in still another aspect, a liquid crystal display device comprising: a plurality of image lines; a plurality of scanning lines; a plurality of thin-film transistors connected to each of the image lines and each of the scanning lines; and an image line drive circuit for supplying an image voltage to each of the image lines, the plurality of thin-film transistors provided between two adjoining image lines along a direction in which the image lines extend having such an arrangement in which thin-film transistors connected to one of the two adjoining image lines and those connected to the other of the two adjoining image lines are alternately arranged, in which polarity of an image voltage supplied from the image line drive circuit to each of the image lines is kept constant during one frame period, and at the same time, between two successive frames, polarity of an image voltage supplied to each image line from the image line drive circuit during the former frame is different from that supplied during the latter frame,

wherein: the image line drive circuit has an amplifier circuit for outputting an image voltage to the image line; the amplifier circuit has a switching unit for connecting one of two input terminals to either of an inverting input terminal or a non-inverting input terminal and also for connecting the other of the two input terminals to the remaining one out of the inverting input terminal and the non-inverting input terminal; and an image voltage produced by adding an offset voltage to a gray-scale voltage and an image voltage produced by subtracting the offset voltage from the gray-scale voltage are supplied alternately via the image line to the thin-film transistor every two successive horizontal-scanning periods.

Effects provided by the representative pieces of the invention disclosed herein can be briefly summarized as below.

With the liquid crystal display device according to the present invention, it is possible to prevent occurrence of flickering on a display screen of a liquid crystal display panel, which is attributed to an offset voltage in an amplifier circuit of an image line drive circuit, thereby improving display quality of the display screen.

### BRIEF DESCRIPTION OF THE DRAWINGS

FIG. 1 is a block diagram illustrating a schematic configuration of a drain driver of a liquid crystal display module according to an embodiment of the present invention;

FIG. 2 is a block diagram illustrating a configuration of the drain driver shown in FIG. 1, centering on a configuration of an output circuit;

FIG. 3 is a diagram illustrating a voltage follower circuit using an operational amplifier;

FIG. 4 is a circuit diagram illustrating a basic circuit configuration of a low-voltage amplifier circuit in the drain driver according to the embodiment of the present invention;

FIG. 5 is a circuit diagram illustrating a basic circuit configuration of a high-voltage amplifier circuit in the drain driver according to the embodiment of the present invention;

FIG. 6 is a circuit diagram illustrating a circuit configuration of the lower-voltage amplifier circuit shown in FIG. 4 when a control signal (A) is at a low level while a control signal (B) is at a high level;

FIG. 7 is a circuit diagram illustrating a circuit configuration of the lower-voltage amplifier circuit shown in FIG. 4 when the control signal (A) is at a high level while the control signal (B) is at a low level;

FIGS. 8A to 8D are diagrams illustrating the polarity of an image voltage output from the drain driver to an image line when the pseudo dot inversion method is used as a AC-drive method for a liquid crystal display module;

FIGS. 9A to 9D are diagrams illustrating an AC-drive method for the liquid crystal display module according to an embodiment of the present invention;

FIGS. 10A to 10D are diagrams illustrating another example of the AC-drive method for the liquid crystal display module according to the embodiment of the present invention;

FIG. 11 is a block diagram illustrating a schematic configuration of a liquid crystal display module based on the conventional technology;

FIG. 12 is a diagram illustrating the column-by-column inversion method in the AC-drive method for a liquid crystal display module; and

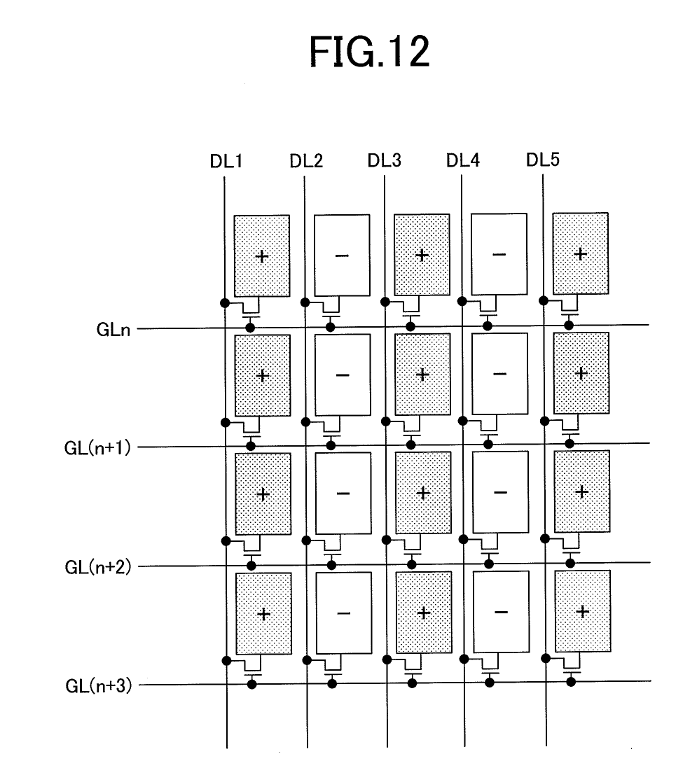

FIG. 13 is a diagram illustrating the pseudo dot inversion method in the Ac-drive method for a liquid crystal display module.

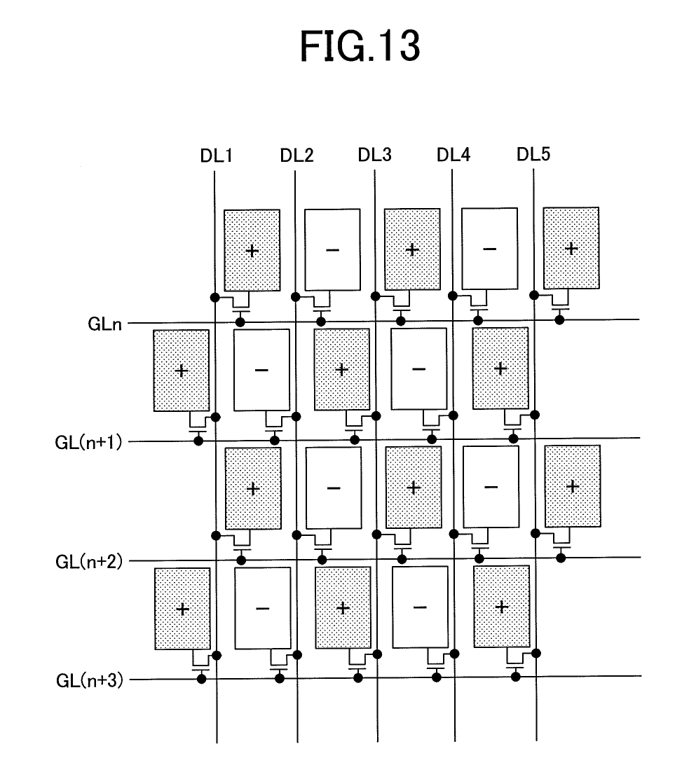

### DESCRIPTION OF REFERENCE NUMERALS AND SYMBOLS

1: Liquid crystal display panel
2, 130: Drain driver
4: Display control circuit
5: Power circuit
151a, 151b: Gray-scale voltage generator circuit
152: Control circuit
153: Shift register circuit
154: Input register circuit
155: Storage register circuit
156: Level shift circuit
157: Output circuit
158a, 158b: Voltage bus line
261: Decoder circuit
262, 264: Switch section
263: Amplifier circuit pair
265: Data latch section
271: High-voltage amplifier circuit
272: Low-voltage amplifier circuit
DL: Image line (drain line)
GL: Scanning line (gate line)
PS: Pixel electrode
CT: Opposite electrode
TFT: Thin-film transistor
LC: Liquid crystal capacitor
Cadd: Storage capacitor
PM, PA, PB: PMOS transistor
NM, NA, NB: NMOS transistor

### Detailed Description of the Preferred Embodiments

An embodiment of the present invention is described below in detail with reference to the accompanying drawings.

It is to be noted that in the drawings illustrating the embodiment, the same reference numerals are given to those having same the function without duplicating explanations.

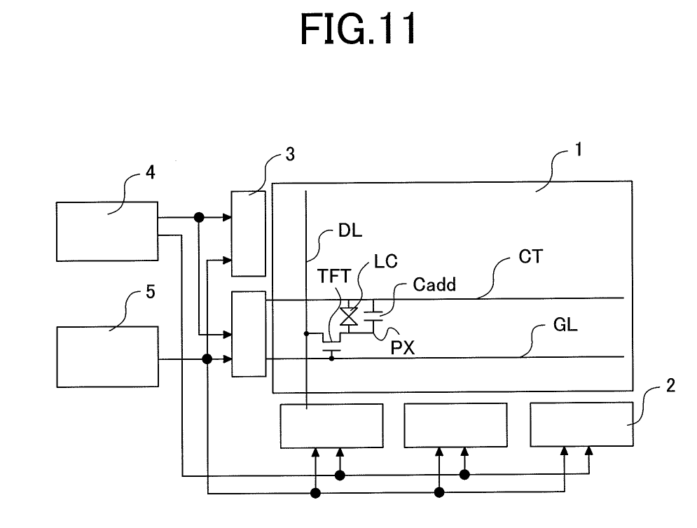

As the schematic configuration of a TFT-system liquid-crystal-display module of the embodiment is the same as that of FIG. 11, detailed explanations therefor are omitted.

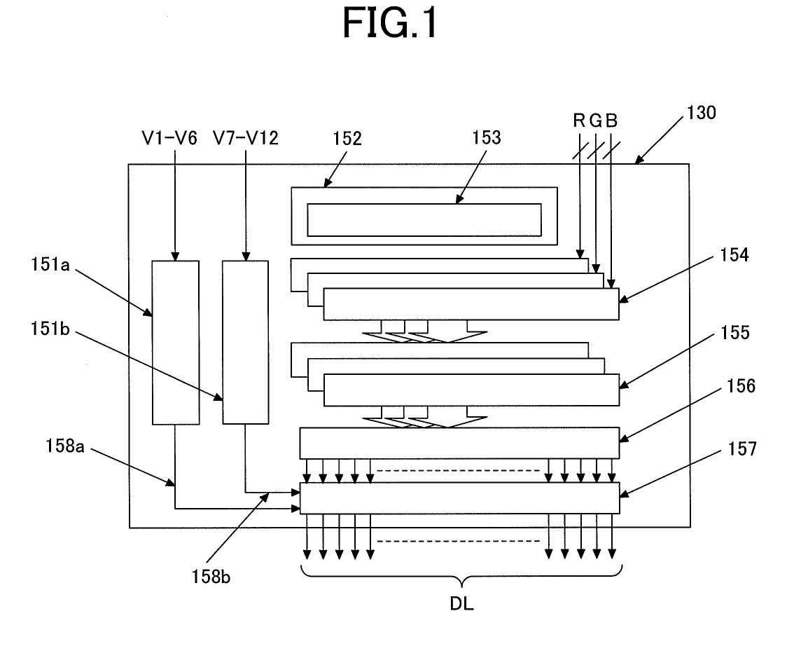

FIG. 1 is a block diagram illustrating the schematic configuration of a drain driver of the liquid crystal display module of the embodiment. In FIG. 1, reference numeral 130 denotes the drain driver, and the drain driver 130 comprises one semiconductor integrated circuit (LSI).

A positive-polarity gray-scale voltage generating circuit 151a generates a 256-gray-scale voltage with positive polarity based on 6-value gray-scale reference voltages (V1-V6) with positive polarity input from a power circuit 5 and outputs the gray-scale voltage to an output circuit 157 via a voltage bus line 158a. A negative-polarity gray-scale voltage generating circuit 151b generates a 256-gray-scale voltage with negative polarity based on 6-value gray-scale reference voltages (V7-V12) with negative polarity input from the power circuit 5 and outputs the gray-scale voltage to the output circuit 157 via a voltage bus line 158b.

A shift register circuit 153 in a control circuit 152 of the drain driver 130 generates a data latch signal for an input register circuit 154 based on a clock (CL2) input from a display control circuit 4 and outputs the signal to an input register circuit 154.

The input register circuit 154 latches for existing output lines 8-bit display data for each color, in synchronization with the clock (CL2) input from the display control circuit 4, based on the data latch signal input from the shift register circuit 153.

A storage resister circuit 155 latches the display data in the input register circuit 154 according to a clock (CL1) input from the display control circuit 4.

The display data fetched by the storage resister circuit 155 is input to the output circuit 157 via a level shift circuit 156. The output circuit 157 selects a gray-scale voltage corresponding to the display data (a voltage associated with one gray-scale out of 256 gray scales) and outputs the voltage to respective image lines (DL) according to the 256-gray-scale voltage with positive polarity or the 256-gray-scale voltage with negative polarity.

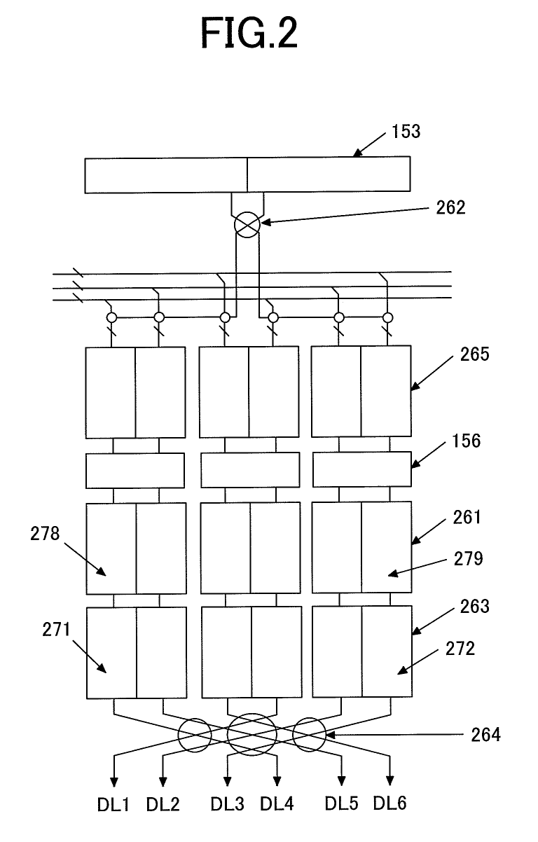

FIG. 2 is a block diagram illustrating the configuration of the drain driver 130 shown in FIG. 1, mainly the configuration of the output circuit 157.

In the figure, reference numeral 153 denotes the shift register circuit in the control circuit 152 shown in FIG. 1. Reference numeral 156 denotes the level shift circuit shown in the FIG. 1. A data latch section 256 denotes the input register circuit 154 and the storage resister circuit 155 both shown in the FIG. 1. Also, a decoder section (a gray-scale voltage selection circuit) 261, an amplifier circuit pair 263, a switch section (2) 264 switching an output of the amplifier circuit pair 263 comprise the output circuit 157 shown in the FIG. 1, wherein a switch section (1) 262 and the switch section (2) 264 are controlled according to an AC-converting current signal (M). Further, DL1, DL2, DL3, DL4, DL5, and DL6 denote a first, second, third, fourth, fifth, and sixth image line (DL), respectively.

In the drain driver 130 shown in FIG. 2, a data latch signal input to the data latch section 265 (more precisely, the input register 154 shown in FIG. 1) is switched by the switch section (1) 262 to input display data for each color to adjoining data latch sections 265 for each color.

The decoder section 261 comprises: a high-voltage decoder circuit 278 which selects a gray-scale voltage with positive polarity corresponding to display data output from each data latch section 265 (more precisely, the storage resister 155 shown in FIG. 1) among 256-gray-scale voltages with positive polarity output from the gray-scale voltage generating circuit 151a via the voltage bus line 158a; and a low-voltage decoder circuit 279 which selects a gray-scale voltage with negative polarity corresponding to display data output from each data latch section 265 among 256-gray-scale voltages with negative polarity output from the gray-scale voltage generating circuit 151b via the voltage bus line 158b. These high-voltage decoder circuit 278 and low-voltage decoder circuit for 279 are provided for each pair of adjoining data latch sections 265.

The amplifier circuit pair 263 comprises a high-voltage amplifier circuit 271 and a low-voltage amplifier circuit 272. A gray-scale voltage with positive polarity generated in the high-voltage decoder circuit 278 is input to the high-voltage amplifier circuit 271, and the high-voltage amplifier circuit 271 generates a gray-scale voltage with positive polarity.

A gray-scale voltage with negative polarity generated in the low-voltage decoder circuit 279 is input to the low-voltage amplifier circuit 272, and the low-voltage amplifier circuit 272 outputs a gray-scale voltage with negative polarity.

In the column-by-column inversion method or in the pseudo dot inversion method, the polarities of adjoining gray-scale voltages for each color are opposite to each other. In addition, the high-voltage amplifier circuit 271 and the low-voltage amplifier circuit 272 in the amplifier circuit pair 263 are arranged in the order from a high-voltage amplifier circuit 271, a low-voltage amplifier circuit 272, another high-voltage amplifier circuit 271, to another low-voltage amplifier circuit 272 (from left to right in FIG. 2). Therefore, it is possible to output a gray-scale voltage with positive polarity or with negative polarity to each image line (DL) by switching data latch signals input to the data latch sections 265 with the switching section (1) 262 to input display data for each color to the adjoining data latch sections 265 for each color and at the same time by switching output voltages output from the high-voltage amplifier circuits 271 or the low-voltage amplifier circuits 272 with the switching section (2) 264 to output the voltages to the image lines (DL), to which gray-scale voltages for each color are output (for instance, to the first image line (D1) and the fourth image line (D4)).

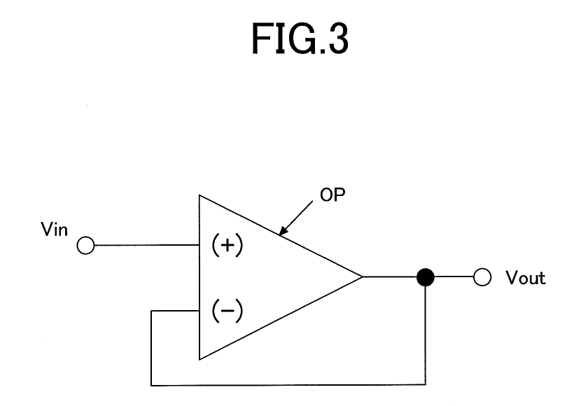

In the conventional technology, the high-voltage amplifier circuit 271 and the low-voltage amplifier circuit 272 are each configured with a voltage follower circuit in which an inverting input terminal (−) of an operational amplifier (OP) is directly connected to an output terminal, and a non-inverting input terminal (+) thereof functions as an input terminal as shown in FIG. 3. An operational amplifier (OP) used in the low-voltage amplifier circuit 272 is a differential amplifier circuit.

Generally, an operational amplifier (OP) has an offset voltage (Voff), however. When a basic amplifier circuit of the operational amplifier (OP) is, for instance, a differential amplifier circuit, the offset voltage (Voff) is generated due to a subtle imbalance in the symmetric property of an MOS transistor in the input stage or that constituting an active load circuit.

When the operational amplifier (OP) is an ideal one without an offset voltage (Voff), its input voltage (Vin) is equal to its output voltage (Vout) (Vin=Vout). In contrast, when the operational amplifier has an offset voltage (Voff), the input voltage (Vin) is not equal to the output voltage (Vout), and the output voltage (Vout) is equal to the sum of the input voltage (Vin) and the offset voltage (Voff) (Vout=Vin+Voff).

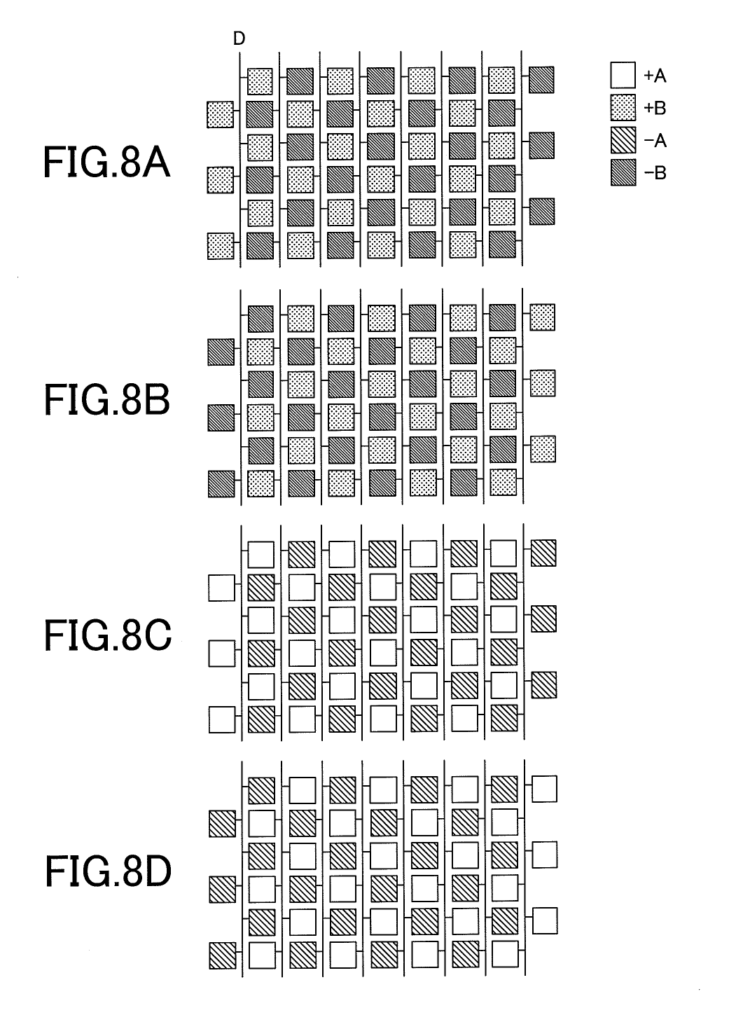

In the conventional type of liquid crystal display module in which the voltage follower circuit as shown in FIG. 8 is used as the high-voltage amplifier circuit (denoted by reference numeral 271 in FIG. 2) and the low-voltage amplifier circuit (denoted by reference numeral 272 shown in FIG. 2) in the output circuit (denoted by reference numeral 157 in FIG. 1) of the drain driver, therefore, an input voltage and an output voltage are not equal to each other in the voltage follower circuit. That is, a liquid crystal drive voltage output from the voltage follower circuit to the drain signal line (DL) is the sum of a gray-scale voltage input to the voltage follower circuit and an offset voltage in the operational amplifier. Because of the above configuration, black or white vertical stripes are generated in a display screen displayed on the liquid crystal panel of the conventional-type liquid crystal display module.

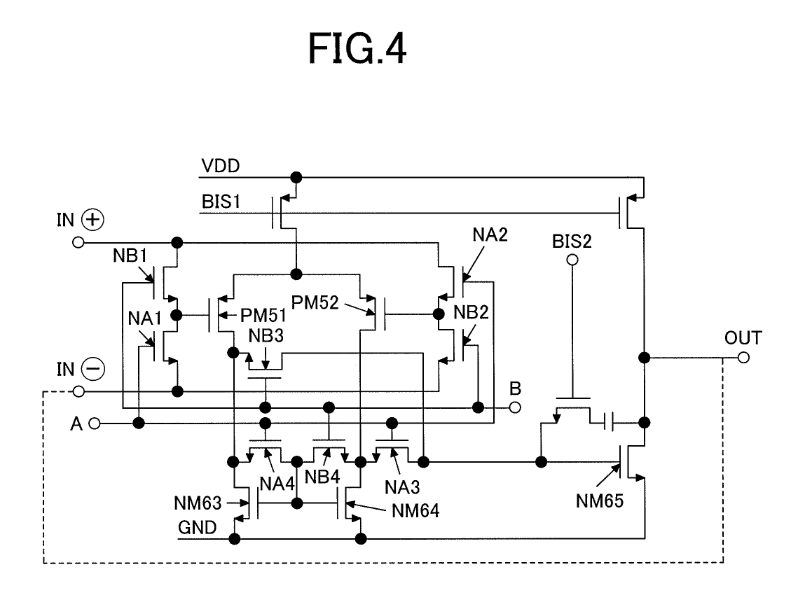

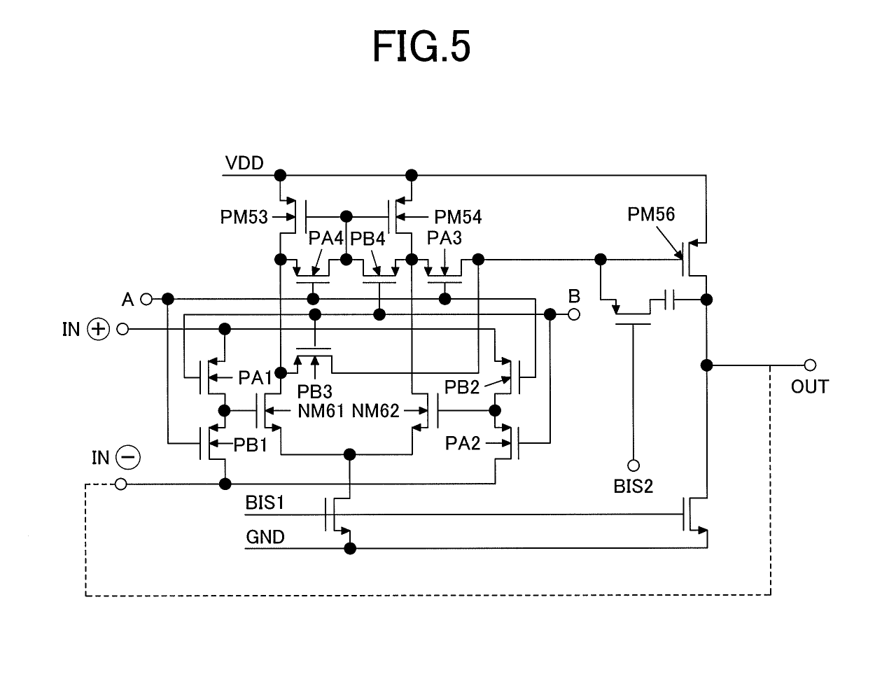

FIG. 4 is a circuit diagram illustrating a basic circuit configuration of the low-voltage amplifier circuit 272 in the drain driver 130 of the embodiment; FIG. 5 is a circuit diagram illustrating a basic circuit configuration of the high-voltage amplifier circuit 271 in the drain driver 130 of the embodiment.

The low-voltage amplifier circuit 272 shown in FIG. 4 additionally includes: switching transistors (NA1 and NB1) for connecting a gate electrode (control electrode) of a PMOS transistor (PM51) in the input stage to a (+) input terminal or a (−) input terminal; switching transistors (NA2 and NB2) for connecting a gate electrode of a PMOS transistor (PM52) in the input stage to a (+) input terminal or (−) input terminal; switching transistors (NA3 and NB3) for connecting a gate electrode of an NMOS transistor (NM65) in the output stage to a drain electrode (second electrode) of the PMOS transistor (PM51) in the input stage or to a drain electrode of the PMOS transistor (PM52) in the input state; and switching transistors (NA4 and NB4) for connecting gate electrodes of NMOS transistors (NM63 and NM64) constituting an active load circuit to the drain electrode of the PMOS transistor (PM51) in the input stage or to the drain electrode of the PMOS transistor (PM52) in the input stage.

Similarly, the high-voltage amplifier circuit 271 shown in FIG. 5 also includes switching transistors (PA1 to PA4; PB1 to PB4) as in the low-voltage amplifier circuit 272 shown in FIG. 4.

A control signal (A) is applied to each gate electrode of the switching transistors (NA1 to NA4; PA1 to PA4) while a control signal (B) is applied to each gate electrode of the switching transistors (NB1 to NB4; PB1 to PB4).

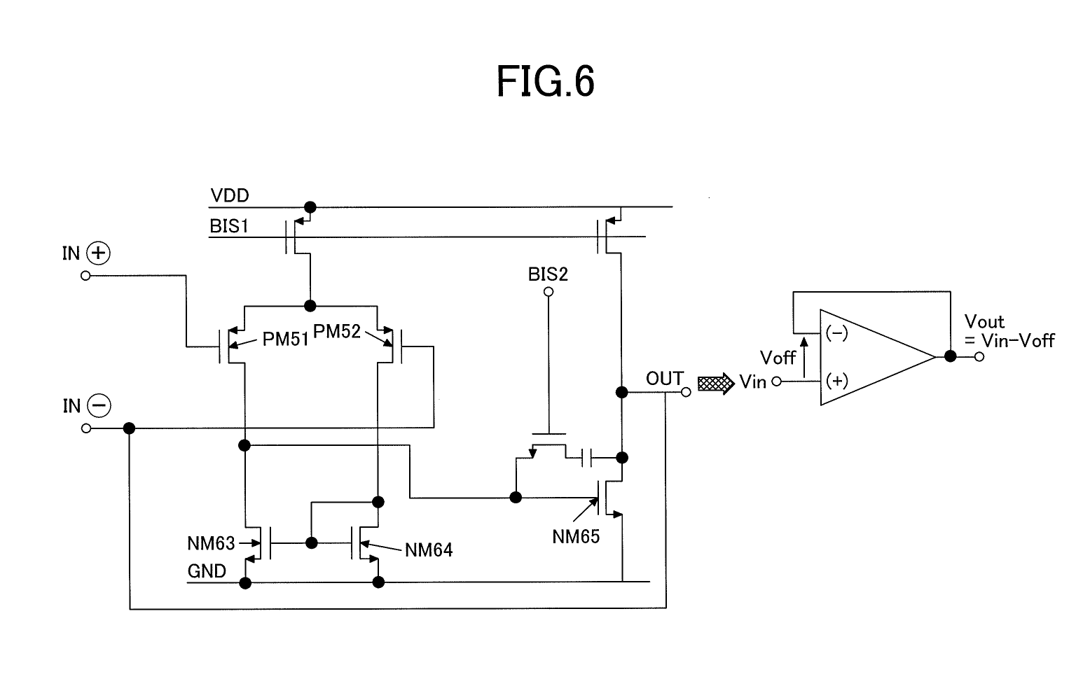

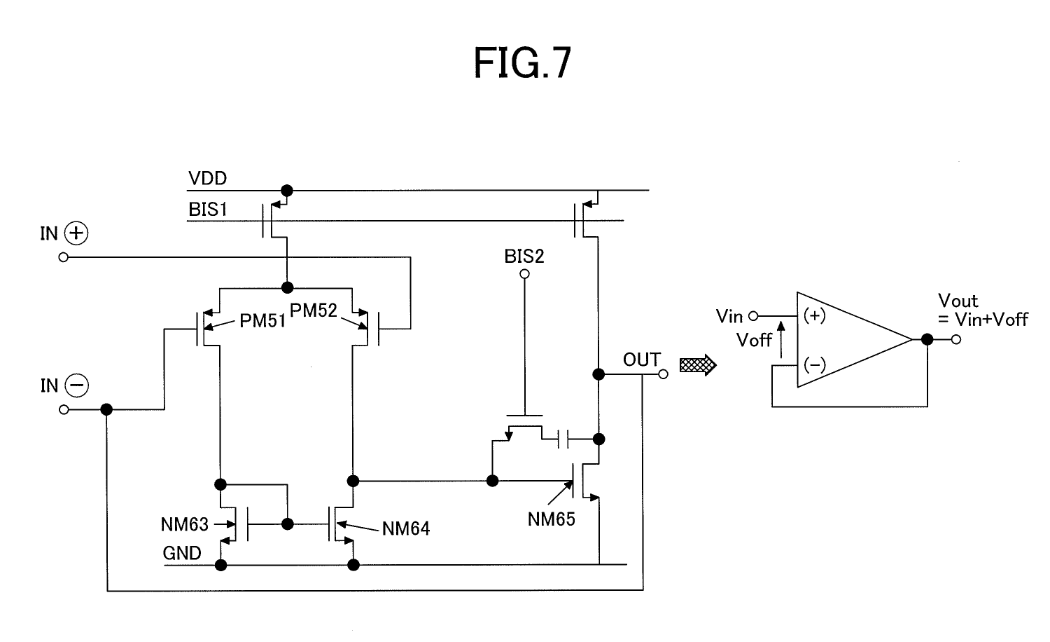

FIG. 6 illustrates a circuit configuration of the low-voltage amplifier circuit 272 according to the embodiment shown in FIG. 4 when the control signal (A) is at a low level (L level) and the control signal (B) is at a high level (H level). FIG. 7 illustrates the same circuit configuration when the control level (A) is at a high level (H level) and the control signal (B) is at a low level (L level). Also shown in FIG. 6 and FIG. 7 are circuit configurations of the amplifier circuits using general operational amplifier signs. Hereinafter, the circuit configuration shown in FIG. 7 is referred to as “the type A low-voltage amplifier circuit 272” while the circuit configuration shown in FIG. 6 is referred to as “the type B low-voltage amplifier circuit 272.”

In the low-voltage amplifier circuit 272 of this embodiment, an MOS transistor in the input stage to which an input voltage (Vin) is applied and an MOS transistor in the input stage to which an output voltage (Vout) is returned are alternately switched.

Because of the configuration described above, in the circuit configuration shown in FIG. 7, the output voltage (Vout) is the sum of the input voltage (Vin) and the offset voltage (Voff), as indicated by formula (1) below.

### Formula 1

Vout=Vin+Voff (1)

In the circuit configuration shown in FIG. 6, a indicated by formula (2) below, the output voltage (Vout) is the difference between the input voltage (Vin) and the offset voltage (Voff).

### Formula 2

Vout=Vin−Voff (2)

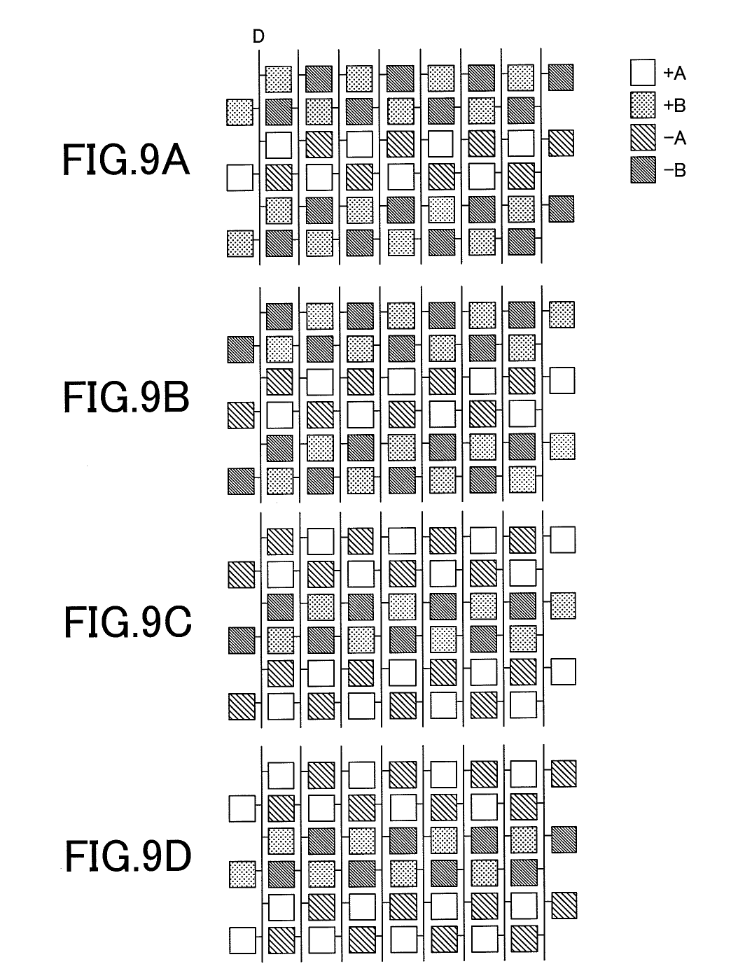

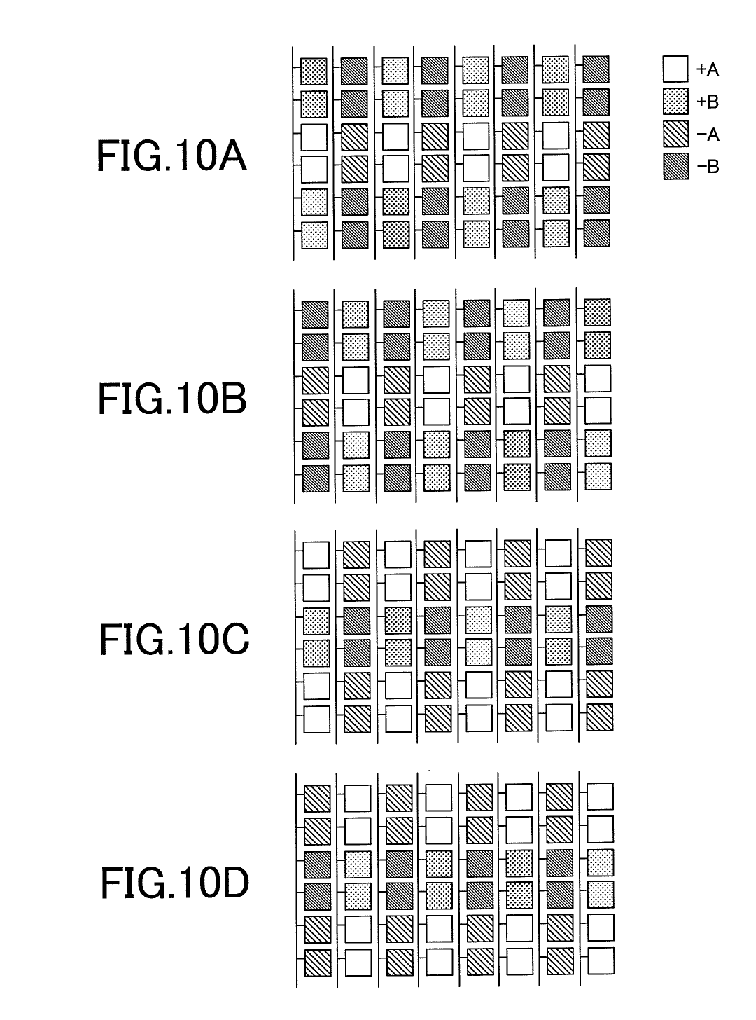

FIGS. 8A to 8D are diagrams showing the polarity of an image voltage output from the drain driver 130 to the image line (DL) when the pseudo dot inversion method is used as an AC-drive method for a liquid crystal display module. In the configuration shown in FIG. 8, phases of the control signal (A) and the control signal (B) are inverted once every two frames. Also in FIGS. 8A to 8D and in FIGS. 9A to 9D and 10A to 10D, which are to be described later, each square represents a pixel electrode.

In FIGS. 8A to 8D, when it is assumed, for instance, that image voltages are output to the image line D from the high-voltage amplifier circuit 271 having an offset voltage (Vofh) and from the low-voltage amplifier circuit 272 having an offset voltage Vofl, a voltage (VH−Vofh)(voltage +B in FIG. 8) is output in the first frame shown in FIG. 8A from the high-voltage amplifier circuit 271 (type B high-voltage amplifier circuit). However, because a voltage (VH+Vofh) (+A in FIG. 8) is output in the third frame shown in FIG. 8C from the high-voltage amplifier circuit 271 (type A high-voltage amplifier circuit), increase or decrease of brightness in an associated sub-pixel generated due to the offset voltage (Vofh) of the high-voltage amplifier circuit 271 is offset.

Furthermore, in the second frame shown in FIG. 8B, a voltage (Vl−Vofl) (−B in FIG. 8) is output from the low-voltage amplifier circuit 272 (type B low-voltage amplifier circuit). However, because a voltage (VL+Vofl) (−A in FIG. 8) is output in the fourth frame shown in FIG. 8D from the low-voltage amplifier circuit 272 (type A low-voltage amplifier circuit), increase or decrease of brightness in an associated sub-pixel generated due to the offset voltage (Vofl) of the low-voltage amplifier circuit 272 is offset.

As will be understood by referring to FIGS. 8A to 8D, however, image voltages are output from the low-voltage amplifier circuit and the high-voltage amplifier circuit, both of which belong to the same type, to image lines in each column within each frame. This leads to a problem that flickering occurs when a certain pattern is displayed on a screen, which degrades the display quality.

FIGS. 9A to 9D are diagrams illustrating an AC-drive method for the liquid crystal display module in this embodiment. The figures show the polarity of an image voltage output from the drain driver 130 to the image line (DL) when the pseudo dot inversion method is employed as an AC-drive method for the liquid crystal display module. In FIGS. 9A to 9D, phases of the control signal (A) and the control signal (B) are inverted once every two lines and also once every two frames.

In FIGS. 9A to 9D, when, for instance, image voltages are output to the image line denoted by sign D from the high-voltage amplifier circuit 271 having an offset voltage Vofh and from the low-voltage amplifier circuit 272 having an offset voltage Vofl, a voltage of (VH−Vofh) (+B in FIG. 9) is output from the high-voltage amplifier circuit 271 (type B high-voltage amplifier circuit) to the first and second lines in the first frame shown in FIG. 9A; a voltage of (VH+Vofh) (+A in FIG. 9) is output from the high-voltage amplifier circuit 271 (type A high-voltage amplifier circuit) to the third and fourth lines in the first frame shown in FIG. 9A.

Because of the configuration described above, in the first frame shown in FIG. 9A, an image voltage is successively supplied to the image line denoted by sign D from the type B high-voltage amplifier circuit, from the type B low-voltage amplifier circuit, from the type A high-voltage amplifier circuit, and from the type A low-voltage amplifier circuit in this order. Therefore, increase and decrease of brightness generated due to offset voltages in the high-voltage amplifier circuits and the lower-voltage amplifier circuits are canceled once every four display lines within one frame.

Likewise, in the second frame shown in FIG. 9B, an image voltage is successively supplied to the image line D from the type B low-voltage amplifier circuit, from the type B high-voltage amplifier circuit, from the type A low-voltage amplifier circuit, and from the type A high-voltage amplifier circuit in this order. Therefore, increase and decrease of brightness generated due to offset voltages in the high-voltage amplifier circuits and the low-voltage amplifier circuits are canceled once every four display lines within one frame. This is also applicable to the third frame shown in FIG. 9C and to the fourth frame shown in FIG. 9D.

Under the AC-drive method of this embodiment, phases of the control signal (A) and the control signal (B) are inverted once every two lines within each frame and also once every two frames, thereby offsetting increase and decrease of brightness generated due to an offset voltage in the amplifier circuit at sub-pixels arranged in the column direction once every four successive frames and also once every four display lines within one frame. This results in no flicker on a screen when a certain pattern is displayed on it, thus not degrading its display quality.

FIGS. 10A to 10D are diagrams illustrating another example of the AC-drive method for the liquid crystal display module in this embodiment. The figures illustrate the polarity of an image voltage output from the drain driver 130 to the image line (DL) when the column-by-column inversion method is employed as the AC-drive method for a liquid crystal display module. FIG. 10 shows a case in which phases of the control signal (A) and the control signal (B) are inverted once every two lines and also once every two frames.

As shown in FIGS. 10A to 10D, image voltages are output from the type A high-voltage amplifier circuit and the type B high-voltage amplifier circuit or from the type A low-voltage amplifier circuit and the type B low-voltage amplifier circuit, respectively, to sub-pixels in each column every two line. Therefore, increase and decrease of brightness generated due to an offset voltage in the amplifier circuit are canceled once every four successive frames and also once every four display lines within one frame. The above configuration results in no flicker on the display screen when a certain pattern is displayed on it, thus not degrading its display quality.

The invention made by the present inventor has been described above in detail with reference to the embodiment, but the present invention is not limited to the embodiment. It is needless to say that various changes and modifications are possible without departing from the gist of the invention.

What is claimed is:

1. A liquid crystal display device comprising:
a plurality of image lines;
a plurality of scanning lines;
a plurality of thin-film transistors connected to each of the image lines and each of the scanning lines; and
an image line drive circuit for supplying an image voltage to each of the image lines,
in which polarity of an image voltage supplied from the image line drive circuit to each of the image lines is kept constant during one frame period, and at the same time, between two successive frames, polarity of an image voltage supplied to each image line from the image line drive circuit during the former frame is different from that supplied during the latter frame,
wherein: the image line drive circuit has an amplifier circuit for outputting an image voltage to the image line;
the amplifier circuit has a switching unit for connecting one of two input terminals to either of an inverting input terminal or a non-inverting input terminal and also for connecting the other of the two input terminals to the remaining one out of the inverting input terminal and the non-inverting input terminal; and
the switching unit switches, according to a switching control signal input every two display lines, one of the two input terminals of the amplifier circuit to an inverting input terminal and the other of the two input terminals to a non-inverting input terminal or switches one of the two input terminals of the amplifier circuit to the non-inverting input terminal and the other of the two input terminals to the inverting input terminal.

2. A liquid crystal display device comprising:
a plurality of image lines;
a plurality of scanning lines;
a plurality of thin-film transistors connected to each of the image lines and each of the scanning lines; and
an image line drive circuit for supplying an image voltage to each of the image lines,
the plurality of thin-film transistors provided between two adjoining image lines along a direction in which the image lines extend having such an arrangement in which thin-film transistors connected to one of the two adjoining image lines and those connected to the other of the two adjoining image lines are alternately arranged, in which polarity of an image voltage supplied from the image line drive circuit to each of the image lines is kept constant during one frame period, and at the same time, between two successive frames, polarity of an image voltage supplied to each image line from the image line drive circuit during the former frame is different from that supplied during the latter frame,
wherein: the image line drive circuit has an amplifier circuit for outputting an image voltage to the image line;
the amplifier circuit has a switching unit for connecting one of two input terminals to either of an inverting input terminal or a non-inverting input terminal and also for connecting the other of the two input terminals to the remaining one out of the inverting input terminal and the non-inverting input terminal; and
the switching unit switches, according to a switching control signal input every two display lines, one of the two input terminals of the amplifier circuit to an inverting input terminal and the other of the two input terminals to a non-inverting input terminal or switches one of the two input terminals of the amplifier circuit to the non-inverting input terminal and the other of the two input terminals to the inverting input terminal.

3. The liquid crystal display device according to claim 1, wherein the image line drive circuit comprises:
a data latch circuit for latching input display data; and
a decoder circuit for selecting a gray-scale voltage based on the display data supplied from the data latch circuit and
wherein the amplifier circuit outputs the gray-scale voltage selected by the decoder circuit as an image voltage to the image line.

4. The liquid crystal display device according to claim 2, wherein the image line drive circuit comprises:
a data latch circuit for latching input display data; and
a decoder circuit for selecting a gray-scale voltage based on the display data supplied from the data latch circuit and
wherein the amplifier circuit outputs the gray-scale voltage selected by the decoder circuit as an image voltage to the image line.

5. The liquid crystal display device according to claim 1, wherein a phase of the switching control signal is inverted every two frames.

6. The liquid crystal display device according to claim 2, wherein a phase of the switching control signal is inverted every two frames.

7. The liquid crystal display device according to claim 1, wherein a cycle of the switching control signal is twice as long as a horizontal scanning time.

8. The liquid crystal display device according to claim 2, wherein a cycle of the switching control signal is twice as long as a horizontal scanning time.

9. A liquid crystal display device comprising:
a plurality of image lines;
a plurality of scanning lines;
a plurality of thin-film transistors connected to each of the image lines and each of the scanning lines; and
an image line drive circuit for supplying an image voltage to each of the image lines,
in which polarity of an image voltage supplied from the image line drive circuit to each of the image lines is kept constant during one frame period, and at the same time, between two successive frames, polarity of an image voltage supplied to each image line from the image line drive circuit during the former frame is different from that supplied during the latter frame,
wherein: the image line drive circuit has an amplifier circuit for outputting an image voltage to the image line;
the amplifier circuit has a switching unit for connecting one of two input terminals to either of an inverting input terminal or a non-inverting input terminal and also for connecting the other of the two input terminals to the remaining one out of the inverting input terminal and the non-inverting input terminal; and
an image voltage produced by adding an offset voltage to a gray-scale voltage and an image voltage produced by subtracting the offset voltage from the gray-scale voltage are supplied alternately via the image line to the thin-film transistor every two successive horizontal-scanning periods.

10. A liquid crystal display device comprising:
a plurality of image lines;
a plurality of scanning lines;
a plurality of thin-film transistors connected to each of the image lines and each of the scanning lines; and
an image line drive circuit for supplying an image voltage to each of the image lines,
the plurality of thin-film transistors provided between two adjoining image lines along a direction in which the image lines extend having such an arrangement in which thin-film transistors connected to one of the two adjoining image lines and those connected to the other of the two adjoining image lines are alternately arranged,
in which polarity of an image voltage supplied from the image line drive circuit to each of the image lines is kept constant during one frame period, and at the same time, between two successive frames, polarity of an image voltage supplied to each image line from the image line drive circuit during the former frame is different from that supplied during the latter frame,
wherein: the image line drive circuit has an amplifier circuit for outputting an image voltage to the image line;
the amplifier circuit has a switching unit for connecting one of two input terminals to either of an inverting input terminal or a non-inverting input terminal and also for connecting the other of the two input terminals to the remaining one out of the inverting input terminal and the non-inverting input terminal; and
an image voltage produced by adding an offset voltage to a gray-scale voltage and an image voltage produced by subtracting the offset voltage from the gray-scale voltage are supplied alternately via the image line to the thin-film transistor every two successive horizontal-scanning periods.
